(19) United States
(12) Patent Application Publication
(10) Pub. No.: US 2011/0248034 A1
(43) Pub. Date: Oct. 13, 2011

(54) FOIL-LID TO CLOSE A TRAY, AND METHOD OF MANUFACTURING SAID FOIL-LID

(76) Inventor: Nadine Hosele, Vienna (AT)

(21) Appl. No.: 13/085,101

(22) Filed: Apr. 12, 2011

(30) Foreign Application Priority Data
Apr. 12, 2010 (EP) 10159671

(51) Int. Cl. B65D 17/32; B32B 38/04

(52) U.S. Cl. 220/269; 156/268

(57) ABSTRACT

Foil lid for closing a container, wherein the foil lid comprises composite layers, wherein the composite layers comprise a first layer group and a second layer group, wherein both the first layer group and the second layer group comprise at least one layer of a first type and one layer of a second type, and the layer of the first type of the first layer group is blocked over its entire area with the layer of the first type of the second layer group, and wherein at least the first layer group, which faces the container when the foil lid is used as intended, comprises a zone of weakness which defines the periphery of an opening.

### CROSS-REFERENCE TO RELATED APPLICATION

The present application claims benefit and priority of European Patent Application No. 10159671 filed Apr. 12, 2010, incorporated herein in its entirety.

### DESCRIPTION

### Technical Field

The invention relates to a foil lid for closing a container.

The invention further relates to a method of producing the foil lid according to the first paragraph.

The invention further relates to a method of use of composite layers for a foil lid according to the first paragraph.

### BACKGROUND

A foil lid of the generic type given in the first paragraph is known for example from the international patent application WO 2005/100197 A2. The disclosed foil lid consists essentially of two layers of a plastic material. During the production of the known foil lid, the composite adherence in regions of the foil lid is changed compared to adjacent regions. The region which has increased composite adherence is used to define an extraction opening. The region with increased composite adherence is produced by the action of heated rollers on the composite layers of the foil lid, the roller surface being structured in correspondence with the opening structures to be produced. The production of the inhomogeneous composite adherence between the layers entails the disadvantage of an additional working step with the use of complex tools.

A foil lid of the generic type given in the first paragraph is also known from the international patent application WO 01/83208 A1. In the present case, an adhesive-containing layer, which is described as a pressure-sensitive adhesive layer, is provided between two layers.

Furthermore, the European patent application EP 1 577 226 A1 likewise discloses a foil lid of the generic type given in the first paragraph, a cold-sealing layer, which is described as a pressure-sensitive adhesive, being provided between two layers of the lid.

For the solutions in which an adhesive-containing layer or a cold-sealing layer is provided between two layers of the foil lid, there is the problem that contact with food or direct skin contact cannot be completely excluded with the said intermediate layer, and therefore only intermediate layers conforming to certain legal standards are permissible. In addition, substances such as latex which are often contained in the intermediate layer can cause allergic reactions in a user of the packaging when the lid is handled.

There is a further problem for all the above-mentioned solutions in the region of the grip tab, with the aid of which the lid or the opening integrated in the lid can be opened. The foil lid must be designed in the region of the grip tab in such a manner that at least the upper layer is freely accessible to be grasped. This is usually solved in such a manner that either the intermediate layer is omitted between two layers or only the upper layer is formed. Both solutions have proven complex and problematic from a production standpoint, because continuous composite layers cannot be used for the whole foil lid.

### SUMMARY

It is therefore the object of the invention to provide a foil lid for closing a container, a method of producing such a foil lid and a use of composite layers for a foil lid, so that the above-mentioned problems are avoided.

This object is achieved by a foil lid according to Claim 1 and by a container according to Claim 7 and by a method for producing a foil lid according to Claim 9, and by a method of use of composite layers for a foil lid according to claim 14.

The subject matter of the invention is therefore a foil lid for closing a container, wherein the foil lid comprises composite layers, wherein the composite layers comprise a first layer group and a second layer group, wherein both the first layer group and the second layer group comprises at least one layer of a first type and one layer of a second type, and the layer of the first type of the first layer group is blocked over its entire area with the layer of the first type of the second layer group. In addition, at least the first layer group, which faces the container when the foil lid is used as intended, comprises a zone of weakness which defines the periphery of an opening.

In addition, the subject matter of the invention is a method of producing a foil lid, wherein the method comprises the following method steps, namely: producing a plastic film tube by extrusion blow moulding, wherein the plastic film tube comprises a wall which has at least one layer of a first type on an inner side of the plastic film tube and one layer of a second type on an outer side of the plastic film tube. Further layers can also be present between the layer of the first type and the layer of the second type.

In this case granules are first liquefied in an extruder in a known manner and an air bubble is produced, around which the liquefied granules are blown into the tube shape, and the liquid plastic is solidified again. The amount of air/granules and the take-off speed determine the thickness of the plastic film tube. The layers of the wall of the plastic film tube are produced by a plurality of layers of different or identical granules, the layers already having been layered one above the other in the liquid state. Layers of the same type or layers of different types are then obtained depending on the granules used.

After the plastic film tube has been produced, the plastic film tube is compressed so that flat composite layers of a plastic film or foil are produced, the composite layers comprise a first layer group and a second layer group, which layer groups are formed by the wall of the plastic film tube, wherein both the first layer group and the second layer group comprise the layer of the first type and the layer of the second type, and the layer of the first type of the first layer group is blocked completely with the layer of the first type of the second layer group. An adhesion-based connection between the layers of the first type is thus produced.

At a later point, a zone of weakness which defines the periphery of an opening is produced in at least the first layer group which faces the container when the foil lid is used as intended.

Furthermore, the subject matter of the invention is a container with a foil lid according to the invention, wherein an opening edge of the container is connected to the foil lid by means of the layer of the second type of the first layer group.

In addition, the subject matter of the invention is a use of composite layers for a foil lid for closing a container, wherein the composite layers are produced with the aid of a plastic film tube which has been produced by extrusion blow moulding and subsequently pressed flat so that the composite layers comprise a first layer group and a second layer group, wherein both the first layer group and the second layer group comprise at least one layer of a first type and one layer of a second type, and the layer of the first type of the first layer groups is blocked over its entire area with the layer of the first type of the second layer group, and wherein the composite layers comprise a zone of weakness which defines the periphery of an opening in at least the first layer group which faces the container when the foil lid is used as intended.

It is advantageously achieved by the measures according to the invention that composite layers blocked with each other—the layers of the first type—are present in the foil lid, between which there are no adhesive-containing or cold-sealing layers, and that precisely these blocked composite layers provide an opening function for the foil lid. As the first layer group which is used for producing the opening in the foil lid is also free from such adhesive-containing or cold-sealing layers, known problems which are caused by contact between food or persons and such adhesive-containing or cold-sealing layers can be excluded. If the foil lid is in its open state, only those zones of the lid which are free from the said adhesive-containing or cold-sealing layers are accessible to the user. The fact that adhesive-containing or cold-sealing layers can if necessary be present in other layers of the foil lid does not change anything in this situation, as these other layers are not themselves freely accessible even when the lid is open.

In addition, the composite layers, which extend continuously over the entire foil lid, have homogeneous composite adherence which is caused by the relatively simple production process. In this process, additional working steps, such as the introduction of adhesive-containing or cold-sealing layers or the production of inhomogeneities in the composite adherence to produce the opening function, are avoided.

In a customary production method for plastic foils or films with composite layers which are produced by coextrusion using the blow-moulding method, also referred to as extrusion blow moulding, a plastic film tube produced using the blow-moulding method is cut in the longitudinal direction so that two foil webs are produced, each of which could be used separately for the foil lid. In addition, additives are usually included in the formula for the plastic, which prevents the blocking of the foil webs stored on rolls. In a departure from this conventional teaching, in the teaching according to the invention, the blocking of the inner layers of the plastic film tube produced using the blow-moulding method is used to realise the composite layers of the foil lid which ultimately provide the opening function. To this end, the formula for at least the layers of the first type, that is, the inner layer of the plastic film tube, is changed to promote blocking. The flat-pressed inner layer of the plastic film tube then blocks using the residual temperature present in the previously produced plastic film tube, wherein the composite adherence of these blocked layers of the composite layers is less than the composite adherence of the layers of the first type and of the second type produced and connected to each other by the extrusion blow moulding process. The composite adherence to be achieved is controlled by the material formula and by the parameters anti-blocking additives, residual temperature and pressure when pressed together. The composite adherence of the layers of the first type which are blocked with each other is also greater than the tear-resistance of the composite layers in the zone of weakness. The region of the composite layers bounding the periphery of the opening can thereby be torn out of the composite layers by introducing force via the blocked layers of the first type, the lid changing from the closed to the open state. As the shape of the opening is independent of the production process of the blocked composite layers, it can be adapted very easily and specifically to the respective customer requirements, which is usually not possible or only possible with considerable additional effort in other solutions.

Although a layer of the first type and a layer of the second type are always mentioned above and below, it should be mentioned for the sake of completeness at this point that additional intermediate layers can be produced in the extrusion blow moulding process.

Further particularly advantageous configurations and developments of the invention can be found in the dependent claims and in the description below. The containers, the production method and in particular the use according to the invention can according to the dependent claims be developed to the foil lid or vice versa.

As mentioned, the blocking of the layer of the first type of the first layer group with the layer of the first type of the second layer group takes place due to the plastic film tube's own residual temperature, which plastic film tube is compressed in order to produce part of the plastic foil for the foil lid. The first layer group and second layer group blocked with each other in this manner are applied to a carrier material after cooling. The entire structure consisting of the plastic-based layer groups and the carrier material is thus referred to as the foil lid. The carrier material can for example be plastic, paper or metal, for example aluminium. Accordingly, the composite layers of the foil lid comprise a carrier material and the carrier material is connected to the second layer group. The connection to the carrier material usually takes place before the said zone of weakness is produced. If the carrier material is realised as a plastic-based carrier foil, this carrier foil is preferably metallised. The metallisation can however be omitted both in the carrier material and in the case of configuration as a carrier foil. Customary functions, usually referred to as barrier functions such as tightness to water vapour or oxygen are realised with the aid of the carrier material. The carrier material can be single-layered, but is preferably multi-layered.

In one embodiment, the zone of weakness can be contained only in one layer or in a plurality of layers of the first layer group. According to a preferred embodiment, the zone of weakness is formed by a line of weakness which has been produced with the aid of a laser beam or by the mechanical action of a tool. The zone of weakness extends through the first and the second layer group as far as the carrier material. When a laser beam is used, the use of a metallised carrier material, in particular a carrier foil, as the carrier material is advantageous, because the metallisation is used to reflect the laser beam so that complete penetration of the composite layers with the laser beam is reliably prevented. The intensity of the laser beam or the duration of its exposure does not therefore have to be controlled precisely, which would be the case without metallisation. The shape of the zone or line of weakness can be continuous or intermittent, it also being possible in particular for irregular distances to be present between intermittent regions of weakened material.

In departure from conventional solutions, in which the adhesive-containing intermediate layers or the cold-sealing intermediate layers between two layers of the composite layers of the foil lid make possible or provide the opening function of the foil lid, according to the invention the blocked layers of the first type have peelable properties which ultimately make the opening function possible.

This means that, when the foil lid is opened, a rupture can be produced or propagated between the first layer group and the second layer group in the region of the blocked layers of the first type. The blocking produces a connection of the layers of the first type which realises a lesser composite adherence than the composite adherence prevailing between the layer of the first type and the layer of the second type of the respective layer group. In other words, this means that the composite adherence produced by the extrusion blow moulding process between the layer of the first type and the layer of the second type is stronger than the composite adherence which is present due to the blocking of the two layers of the first type of the respective layer group.

The peelable properties are in stark contrast to known production methods of blocked composite foils, in the production of which the process management or control of the process parameters is such that peelability is avoided as far as possible. The production of such blocked composite foils actually proceeds from the problem that the number of layers produced by coextrusion is not sufficient. In order to double the number of layers, the blocking process is used, a maximum possible composite adherence between the blocked layers being the aim, which adherence corresponds to the layers produced by coextrusion, in order to ensure the required homogeneity and durability of the composite foil.

According to a further aspect of the invention, the layer of the second type has fast-sealing properties in relation to the material of the container, a greater composite adherence being realised in the sealed fast state with an opening edge of the container than the composite adherence prevailing between the blocked layers of the first type. This ensures that the foil lid does not unintentionally tear off from the opening edge of the container when the composite layers are torn apart. The opening function integrated in the foil lid can thus be used in a targeted manner to expose the opening.

In a preferred embodiment, the carrier material is connected to the second layer group by adhesive lamination, and the adhesive lamination realises a greater composite adherence than the composite adherence prevailing between the blocked layers of the first type. This relationship of the composite adherence between the individual layers of the composite layers also ensures that the desired rupture in the composite layers propagates along the layers of the first type which are blocked with each other when the foil lid is opened.

In a preferred embodiment, the foil lid has a tab for grasping in order to effect opening of the foil lid. The connection between the foil lid and the opening edge of the container is preferably produced by hot sealing. As the composite layers extend continuously through the foil lid or over the entire area thereof, that is, are also present in the tab, a kink is first produced in the foil lid along the sealed opening edge when the tab is lifted. At this opening edge, the first layer group which is sealed fast to the opening edge now begins to tear, the tear propagating transversely to the composite layers in the composite layers only as far as the blocked layers of the first type. As soon as the tear in the composite layers reaches the blocked region between the layers of the first type of the first layer group, the direction of the tear changes and a rupture is produced along the composite layers of the foil lid, which propagates along the blocking zone of the blocked layers of the first type.

When the tab is further lifted, the rupture in the composite layers finally reaches the zone of weakness which defines the periphery of the opening in the foil lid. The zone of weakness is created in such a manner that the rupture does not continue into the opening but continues in the composite layers around the opening, following the zone of weakness. When the tab is further lifted, a region of the first layer group which is delimited by the zone of weakness is torn out of the first layer group. The said opening of a defined size is thereby formed in the first layer group remaining on the opening edge of the container, which opening allows dosed dispensing of substances or products contained in the container. Depending on the application, the part of the composite layers connected to the tab can then be torn off completely from the first layer group remaining on the opening edge of the container or optionally folded back onto the first layer group for temporary sealing or covering of the opening.

The aspects and advantages given above in relation to the foil lid are also produced analogously for the container with the foil lid according to the invention, the method for producing the foil lid and the use of the composite layers for a foil lid.

The foil lid can in principle be produced from composite materials of different materials and/or plastic types. The layers of the first and second types are preferably formed from coextruded polyethylene (PE). The carrier material can for example be based on polyester (PET). The carrier material can have a layer or a plurality of layers of plastic, metallic layers, paper layers or a combination of plastic layers with metallic layers and/or also paper layers etc. or be formed therefrom. The carrier material on the outer foil side usually has a non-sealable material which can be printed according to customer requirements. With the realisation as a carrier foil which is metallised, it is advantageous if the metallisation is arranged on the side of the foil facing the container, that is, the inner side of the carrier foil. Any adhesive known in practice with which the desired composite adherence relationships can be realised can be used as the adhesives for fastening the coextruded PE layers to the carrier material.

### BRIEF DESCRIPTION OF THE FIGURES

The invention is explained in more detail below with reference to the attached figures and using exemplary embodiments, to which the invention is not limited. In the different figures, the same components are provided with identical reference symbols. In the figures,

FIG. 1 schematically shows a cross section through composite layers which are used for a foil lid according to the invention;

FIG. 2 schematically shows a view of the foil lid according to the invention from a first perspective;

FIG. 3 schematically shows a view of the foil lid according to the invention from a second perspective in the open state on a container.

### DESCRIPTION OF THE EXEMPLARY EMBODIMENTS

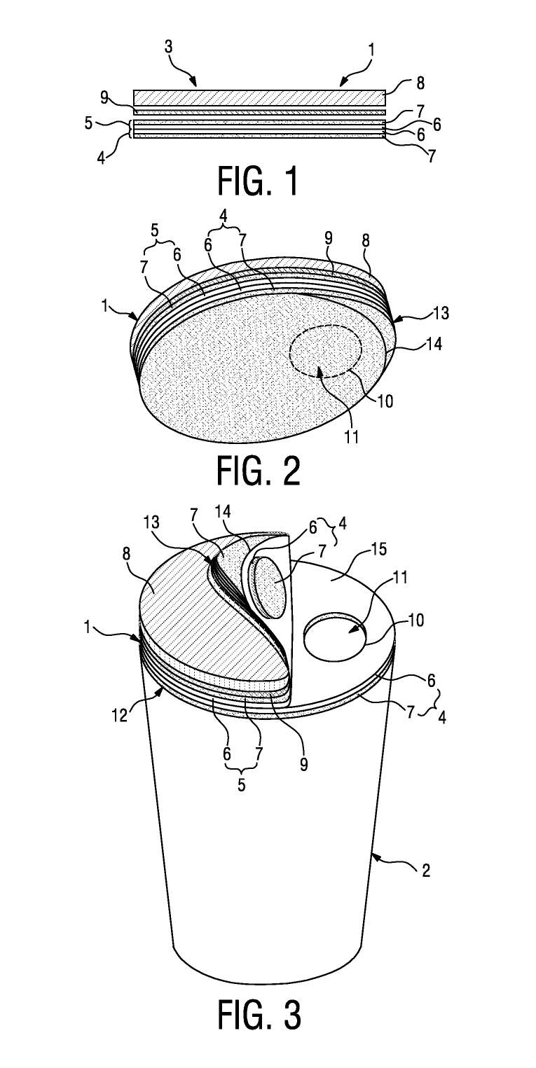

FIG. 1 shows a cross section through the composite layers 3 of a foil lid 1, which is used to close a container 2 (see FIG. 3). The composite layers 3 have a first layer group 4 and a second layer group 5. The first layer group 4 has a layer of a first type 6 and a layer of a second type 7. The second layer group 5 also has a layer of the first type 6 and of the second type 7. The two layers of the first type 6 are identical. The two layers of the second type 7 are likewise identical.

The two layer groups 4 and 5 have been produced by coextrusion using the blow-moulding method, wherein a plastic film tube (not shown) was produced, the wall of which is formed by the layer of the first type 6 (inner wall of the plastic film tube) and by the layer of the second type 7 (outer wall of the plastic film tube). The plastic film tube produced in this manner was then compressed so that the layer of the first type 6 situated on the inner wall could block with each other with the aid of the residual heat. In the present case the two layer groups are coextruded PE. In order to be able to use the effect of blocking between the layers of the first type 6 for an opening function of the foil lid 1, fewer anti-blocking substances were added to the granules for producing the layers of the first type 6 than is usually the case when producing a coextruded foil in which blocking is an undesirable effect.

The composite layers 3 further have a carrier material 8, which in the present case is realised as a plastic-based carrier foil 8 which is connected to the layer of the second type 7 of the second layer group 5 by means of an adhesive layer 9. The carrier foil 8 is realised by PET which is metallised on the side facing the second layer group 5.

The foil lid 1 also has a zone of weakness 10 which defines a circular opening 11. The zone of weakness 10 is formed by a laser perforation which extends through the first and the second layer group 4 and 5 as far as the carrier foil 8. When the laser is used for producing the laser perforation 10, the laser beam melts the material of the two layer groups 4 and 5 and allows it to evaporate, wherein the laser does not however penetrate through the carrier foil 8 but is reflected on the metallisation owing to the same.

The foil lid 1 is shown in FIG. 3 connected to the container 2. The connection between the foil lid 1 and the container 2 has been produced by hot sealing an opening edge 12 of the container 2 (only shown schematically) to the layer of the second type 7 of the first layer group 4. In this sealed fast state, there is greater composite adherence between the opening edge 12 and the layer of the second type 7 sealed thereto than the composite adherence prevailing between the blocked layers of the first type 6. There is likewise a greater composite adherence between the carrier foil 8 and the layer of the second type 7 of the second layer group 5 than the composite adherence prevailing between the blocked layers of the first type 6.

These relationships of the different levels of composite adherence then allow a flat rupture to be produced between the layers of the first type 6 which are blocked with each other when a tab 13 is torn. The tab 13 projects over the opening edge 12 of the container 2 and has the same composite layers 3 in its structure as the part of the composite layers 3 of the foil lid 1 which seals off the container. The composite layers 3 thus run over the entire area of the foil lid 1, including the tab 13.

An already opened container, that is, with an activated opening function, is shown in FIG. 3. In this diagram, the tab 13 has already been lifted or pulled to the left in the drawing plane until the opening 11 in the first layer group 4 was opened. The process of opening is described in detail below.

Starting from the closed container, from which the tab 13 would stand out to the right in the drawing plane, first a kink is produced in the composite layers 3 when the tab 13 is lifted, which kink extends along the opening edge 12. When the tab 13 is further lifted or torn, a tear is produced initially in the underside of the composite layers 3 in the first layer group 4, which tear propagates along a tear line 14. The course of the tear line is essentially defined by the outer edge of the opening edge 12. The course of the tear can however also be predefined by a material weakness which can in turn be introduced into the composite layers by a laser beam or by other mechanical means.

When the tab 13 is pulled further, the tear propagates transversely to the layer-shaped course of the composite layers 3 into the interior of the composite layers 3 until it finally reaches the zone in which the two layers of the first type 6 are blocked with each other. From this point the tear propagates in a flat manner along a rupture area 15 through the blocking zone of the layers of the first type 6 which are blocked with each other, until the situation of the opened container 2 shown in FIG. 3 is finally reached. After the opening 11 has been completely exposed, it can clearly be seen that a part situated in the region of the tab 13 and a part situated in the region of the opening 11 has been torn out of the first layer group 4 adhering to the opening edge. The torn out parts adhere to the folded up part of the foil lid 1.

In contrast to known solutions, which would use adhesive-containing or cold-sealing intermediate layers between two layers of composite layers to provide the opening function in a foil lid, the solution according to the invention arrives at the realisation of the opening function without such intermediate layers and makes use of the blocked layer structure in order to provide the opening function. The adhesive layer 9 is not freely accessible. The opening function is therefore obtained by the physical properties of the layers of the first type 6 which are blocked with each other. The foil lid 1 produced in this manner has the same layer structure for realising the tab 13 as the layer structure which was obtained by the process of extrusion blow moulding and compressing the produced plastic film tube. No complex configurations are therefore necessary in the region of the tab 13 for realising the function of initiating the tear and therefore no further working steps are necessary for the production thereof. This configuration of the tab 13 also simplifies the grasping and handling of the tab 13 compared to known tab solutions. The shape of the tab 13 can thus also be adapted very easily to customer requirements.

The foil lid 1 can therefore easily be punched out of a foil web and placed in a magazine in order to be supplied for subsequent processing following transport or storage, or directly processed.

It is finally pointed out again that the embodiment described in detail above is only an exemplary embodiment which can be modified by a person skilled in the art in a wide variety of ways without departing from the scope of the invention. It is also pointed out for the sake of completeness that the use of the indefinite article “a” or “an” does not exclude the relevant features from being present plurally. Features of other exemplary embodiments disclosed in connection with one exemplary embodiment can also be used in combination with features disclosed there. The proportions of the features shown can also vary without deviating from the concept of the invention.

### LIST OF REFERENCE SYMBOLS

1 Foil lid
2 Container
3 Composite layers
4 First layer group
5 Second layer group
6 Layer of the first type
7 Layer of the second type
8 Carrier material, carrier foil
9 Adhesive layer
10 Zone of weakness
11 Opening
12 Opening edge of container
13 Tab
14 Tear line
15 Rupture area through blocking zone

1. Foil lid for closing a container,
wherein the foil lid comprises composite layers, wherein the composite layers comprise a first layer group and a second layer group,
wherein both the first layer group and the second layer group comprise at least one layer of a first type and one layer of a second type, and the layer of the first type of the first layer group is blocked over its entire area with the layer of the first type of the second layer group, and
wherein at least the first layer group, which faces the container when the foil lid is used for closing a container, comprises a zone of weakness which defines the periphery of an opening.

2. Foil lid according to claim 1, wherein the composite layers comprise a carrier material, in particular a carrier foil, and the carrier material is connected to the second layer group and, in particular when configured as a carrier foil, may be metallised.

3. Foil lid according to claim 2, wherein the zone of weakness is formed by a line of weakness which has been produced with the aid of a laser beam or by a mechanical action of a tool and extends through the first and second layer groups as far as the carrier material.

4. Foil lid according to claim 1, wherein the blocked layers of the first type are peelable.

5. Foil lid according to claim 1, wherein the layer of the second type has fast-sealing properties in relation to the material of the container, and realises a greater composite adherence in the sealed fast state with an opening edge of the container than the composite adherence prevailing between the blocked layers of the first type.

6. Foil lid according to claim 2, wherein the carrier material is connected to the second layer group by adhesive lamination and the adhesive lamination realises a greater composite adherence than the composite adherence prevailing between the blocked layers of the first type.

7. Container with a foil lid according to claim 1, wherein an opening edge of the container is connected to the foil lid by means of the layer of the second type of the first layer group.

8. Container according to claim 7, wherein the connection between the foil lid and the opening edge is produced by hot sealing.

9. Method of producing a foil lid for closing a container, wherein the foil lid comprises composite layers, wherein the composite layers comprise a first layer group and a second layer group,
wherein both the first layer group and the second layer group comprise at least one layer of a first type and one layer of a second type, and the layer of the first type of the first layer group is blocked over its entire area with the layer of the first type of the second layer group, and
wherein at least the first layer group, which faces the container when the foil lid is used for closing a container, comprises a zone of weakness which defines the periphery of an opening;
wherein the method comprises the following method steps, namely:
producing a plastic film tube by extrusion blow moulding, wherein the plastic film tube comprises a wall which comprises at least one layer of a first type on an inner side of the plastic film tube and one layer of a second type on an outer side of the plastic film tube, and
compressing the plastic film tube so that flat composite layers are produced, wherein the composite layers comprise a first layer group and a second layer group, which layer groups are formed by the wall of the plastic film tube, wherein both the first layer group and the second layer group comprise the layer of the first type and the layer of the second type, and the layer of the first type of the first layer group is blocked over its entire area with the layer of the first type of the second layer group, and
producing a zone of weakness which defines the periphery of an opening in at least the first layer group which faces the container when the foil lid is used as intended.

10. Method according to claim 9, wherein, before the zone of weakness is produced, the composite layers are applied to a carrier material, in such a manner that the carrier material is connected to the second layer groups and faces away from the container when the foil lid is used for closing a container.

11. Method according to claim 10, wherein a line of weakness which forms the zone of weakness is produced by the action of a laser beam or by the mechanical action of a tool, wherein the zone of weakness extends through the first and the second layer group as far as the carrier material.

12. Method according to claim 10, wherein the carrier material is connected to the second layer group by adhesive lamination.

13. Method according to claim 9, wherein the foil lid is punched out of the composite layers.

14. Method of use of composite layers for producing a foil lid for closing a container, comprising the steps of:
producing the composite layers with the aid of a plastic film tube which has been produced by extrusion blow moulding and subsequently pressed flat so that the composite layers comprise a first layer group and a second layer group, wherein both the first layer group and the second layer group comprise at least one layer of a first type and a layer of a second type, and the layer of the first type of the first layer group is blocked over its entire area with the layer of the first type of the second layer group, and
producing a zone of weakness in the composite layers which defines the periphery of an opening in at least the first layer group which faces the container when the foil lid is used for closing a container.

15. Method according to claim 10, wherein said carrier material is a carrier foil.

16. Method according to claim 15, wherein said carrier foil is metallised.
